(19) United States
(12) Patent Application Publication
(10) Pub. No.: US 2015/0017511 A1
(43) Pub. Date: Jan. 15, 2015

(54) HIGHLY POROUS SEPARATOR FILM HAVING A COATING AND A DISCONNECTING FUNCTION

(71) Applicant: Treofan Germany GmbH & Co. KG, Neunkirchen (DE)

(72) Inventors: Bertram Schmitz, Sarreguemines (FR); Detlef Busch, Saarlouis (DE); Dominic Klein, Bexbach (DE)

(21) Appl. No.: 14/366,464

(22) PCT Filed: Dec. 17, 2012
(86) PCT No.: PCT/EP2012/005204

§ 371 Date: Jun. 18, 2014

(30) Foreign Application Priority Data
Dec. 20, 2011 (DE) 10 2011 121 606.9

(51) Int. Cl. H01M 2/16; H01M 10/42; B29C 71/00; H01M 2/14; B29C 47/00; B29C 55/14

(52) U.S. Cl. CPC H01M 2/1686; B29C 47/0057; B29C 55/14; B29C 71/0009; H01M 2/145; B29C 47/0021; H01M 10/4235; B29K 2023/12
USPC 429/145; 264/129

(57) ABSTRACT

The invention concerns a biaxially orientated, single- or multi-layered porous film which comprises at least one porous layer and this layer contains at least one propylene polymer and polyethylene;
(i) the porosity of the porous film is 30% to 80%; and
(ii) the permeability of the porous film is <1000 s (Gurley number);
   characterized in that
(iii) the porous film comprises an inorganic, preferably ceramic coating; and
(iv) the coated porous film has a Gurley number of <1500 s; and
(v) the coated porous film has a Gurley number of >6000 s when it is heated for 5 minutes to over 140° C.

The coated, porous film has dual safety features. Furthermore, the invention also concerns a process for the production of a film of this type as well as its use in high energy or high performance systems, in particular in lithium, lithium ion, lithium-polymer and alkaline-earth batteries.

The present invention relates to a dual safety coated, porous film and to its use as a separator, as well as to a process for the production of the film.

Modern devices require an energy source such as batteries or rechargeable batteries which can be used irrespective of location. Batteries suffer from the disadvantage that they have to be disposed of. Consequently, more and more use is being made of rechargeable batteries (secondary batteries), which can be recharged repeatedly with the aid of charging units connected to the mains electrical supply. As an example, if used correctly, conventional nickel-cadmium rechargeable batteries (NiCd rechargeable batteries) can have a service life extending to about 1000 charge cycles.

High energy and high performance systems are now making increasing use of lithium, lithium ion, lithium-polymer and alkaline-earth batteries as rechargeable batteries.

Batteries and rechargeable batteries always consist of two electrodes, which are immersed in an electrolyte solution, and a separator which separates the anode and the cathode. The various rechargeable battery types differ in the electrode material used, the electrolyte and the separator used. The task of a battery separator is to keep the cathode physically separated from the anode in batteries, or the negative electrode physically separated from the positive electrode in rechargeable batteries. The separator must be a barrier which electrically isolates the two electrodes from one another in order to prevent internal short circuits. At the same time, however, the separator must be permeable to ions in order to enable the electrochemical reactions to take place in the cell.

A battery separator must be thin so that the internal resistance is as low as possible and a high packing density can be obtained. This is the only way to ensure good performance characteristics and high capacitances. In addition, the separators have to absorb the electrolyte and ensure gas exchange when the cells are full. Whereas previously, woven fabrics and the like were used, this function is now primarily fulfilled by fine-pored materials such as nonwovens and membranes.

In lithium batteries, the occurrence of short-circuits is a problem. Under the thermal load resulting from short circuits or defective cooling systems, the battery separator in lithium ion batteries can melt, leading to a short-circuit with disastrous results. Similar risks exist if the lithium batteries are damaged mechanically or are overcharged due to defective electronics in the charging units.

In order to improve the safety of lithium ion batteries, in the past, shut down separators (shut down membranes) were developed. Such special separators close their pores very rapidly at a given temperature which is significantly lower than the melting point or ignition point of lithium. In this manner, the catastrophic consequences of a short-circuit in lithium batteries are largely avoided.

At the same time, however, separators also need to have great mechanical strength, which is provided by materials with high melting points. Thus, for example, polypropylene membranes are advantageous because of their good puncture resistance, but the melting point of polypropylene is approximately 164° C., very close to the flash point of lithium (170° C.).

High-energy batteries based on lithium technology are deployed in applications where as much electrical energy as possible has to be available in the least possible volume. This is the case, for example, with traction batteries for use in electric vehicles, and also in other mobile applications in which a maximum energy density is required for low weight, for example in air and space travel. Currently, energy densities of 350 to 400 Wh/L or 150 to 200 Wh/kg are targeted for high energy batteries. These high energy densities are obtained by using special electrode materials (for example Li—CoO₂) and the economic use of housing materials. Thus, in Li batteries of the pouch cell type, the individual battery units are now separated from each other by only a film.

For this reason, even greater demands are made of the separators in such cells, since in the event of an internal short-circuit and overheating, the explosion-like combustion reactions spread to the neighbouring cells.

Separator materials for such applications must have the following properties: they must be as thin as possible in order to guarantee a small specific volume and in order to keep the internal resistance low. In order to ensure such a low internal resistance, it is also important for the separator to have a high porosity. Furthermore, they must be light so that they have a low specific weight, and they must be completely safe. This means that in the event of overheating or mechanical damage, the positive and negative electrodes remain separated at all times in order to avoid further chemical reactions which result in fire or explosion of the batteries.

In the prior art, a combination of polypropylene membranes with additional layers which are constructed from materials with a lower melting point, for example polyethylene, are known. In the event of overheating due to short-circuit or other external influences, the polyethylene layer melts and closes the pores of the porous polypropylene layer (shut down function) whereupon the flow of ions in the battery, and thus the flow of current, is interrupted. Furthermore, with a further increase in temperature (>160° C.), the polypropylene layer also melts and an internal short-circuit due to the anode and cathode coming into contact and consequential problems such as auto-ignition and explosion can no longer be prevented. Moreover, adhesion of the polyethylene layers to polypropylene is problematical, so that these layers can only be combined by lamination, or only selected polymers of these two classes can be co-extruded. Such separators in high energy applications are inadequate as regards safety. A film of this type with a shut down function is described in WO 2010048395.

US2011171523 describes a heat-resistant separator which is obtained by means of a solvent process. In that process, in a first step, inorganic particles (chalk, silicates or aluminium oxide) is compounded into the raw material (UHMW-PE) together with an oil. This blend is then extruded through a die to form a pre-film, the oil can be removed from the pre-film using a solvent in order to create pores, and then this film can be drawn to form the separator. Thus, the inorganic particles in that separator ensure that the anode and cathode in the battery are kept separate, even with severe overheating.

However, that process suffers from the disadvantage that the particles contribute to weakening the mechanical properties of the separator and in addition, flaws and an irregular pore structure can arise due to agglomerates of the particles.

US2007020525 describes a ceramic separator which is obtained by processing inorganic particles with a binder based on a polymer. This separator also ensures that the anode and cathode in the battery remain separated when severely overheated. However, the production process is costly and the mechanical properties of the separator are insufficient.

DE19838800 proposes an electrical separator with a laminated structure which comprises a flat, flexible substrate provided with a plurality of openings and having a coating thereon. The material of the substrates is selected from metals, alloys, plastics, glass and carbon fibres or a combination of such materials, and the coating is a flat, continuous, porous ceramic coating which does not conduct electricity. Using a ceramic coating promises heat and chemical resistance. Separators of that type are very thick, however, because of the support material and have proved to be problematic to produce since a flaw-free, extensive coating can only be produced with a considerable technical outlay.

In DE10208277, the weight and thickness of the separator is reduced by using a nonwoven polymer, but here again, the embodiments described therein of a separator do not satisfy all the requirements placed on a separator for a lithium high energy battery, in particular because in that application, particular emphasis is laid on having pores in the separator which are as large as possible. However, with the particles described therein, which are up to 5 μm, it is not possible to produce 10 to 40 μm thick separators since in this case only a few particles could lie one on top of the other. Thus, the separator would necessarily have a high flaw and defect density (for example holes, cracks, etc.).

WO 2005038946 describes a heat-resistant separator which comprises a support formed from woven or nonwoven polymer fibres which is bonded with a porous inorganic ceramic layer on and in this support which is bonded with the support using an adhesive. Here again, ensuring that the coating is free of flaws and the resulting thickness and weight are problematic.

Coating drawn polypropylene films with inorganic materials has not until now been carried out very much, since it is known that the adhesion of coating layers is highly unsatisfactory and thus primers have to be employed. This problem has been described in U.S. Pat. No. 4,794,136, for example. Here, the use of a melamine/acrylate primer as a primer between polyolefin films and PVDC coatings is described. However, primers have a tendency to close the pores, and so the resistance climbs unnecessarily. Flaking of the coating during preparation of the battery constitutes an additional safety risk. Furthermore, the primer must be insoluble in the organic electrolytes used in Li batteries in order, inter alia, not to have a negative effect on the conductivity of the electrolytes.

Surprisingly, it has been discovered that polypropylene separators with a specific surface structure exhibit sufficient adhesion to aqueous inorganic, preferably ceramic coatings for further processing without the use of primers. Adhesion to a plurality of coatings is also ensured without the use of a primer.

Polyolefin separators can currently be produced using various processes: filler material processes; cold drawing, extraction processes, and β-crystallite processes. The fundamental differences between these processes lie in the various mechanisms via which the pores are produced.

As an example, porous films may be produced by adding very large quantities of filler materials. The pores are created during drawing due to the incompatibility of the filler materials with the polymer matrix. The large quantities of filler materials of up to 40% by weight required to obtain high porosities, however, have a deleterious effect on the mechanical strength despite high drawing ratios, so such products cannot be used as separators in high energy cells.

In so-called “extraction processes”, the pores are in principle created by the release of a component from the polymer matrix using suitable solvents. A large number of variations have been developed, which differ in the nature of the additives and the appropriate solvents. Both organic and inorganic additives can be extracted. Extraction of this type can be carried out as the last process step in producing the film, or it may be combined with a subsequent drawing step. The disadvantage in this case is the ecologically and economically critical extraction step.

An older but successful process is based on drawing the polymer matrix at very low temperatures (cold drawing). To this end, the film is first extruded and then tempered for several hours to increase its crystalline component. In the next process step, the film is drawn in the longitudinal direction at very low temperatures in order to create a large number of flaws in the form of very tiny micro-cracks. This pre-drawn film with flaws is then drawn in the same direction again at a higher temperature and with higher factors; this enlarges the defects into pores which form a network-like structure. These films combine high porosities as well as good mechanical strength in the direction in which they are drawn, generally the longitudinal direction. However, their mechanical strength in the transverse direction is still unsatisfactory, so that their puncture resistance is poor, and they are highly susceptible to splitting in the longitudinal direction. Overall, the process is cost-intensive.

Another known process for producing porous films is based on admixing β-nucleation agents with polypropylene. Because of the β-nucleation agent, the polypropylene form: high concentrations of “β-crystallites” as the melt cools down. During the subsequent longitudinal drawing, the β-phase is transformed into the alpha-modification of the polypropylene. Since these different crystalline forms have different densities, a large number of microscopic flaws are also initially created in this step, which are torn into pores by the subsequent drawing. The films produced by this process have high porosities and good mechanical strengths in the longitudinal and transverse directions, and they are very cost-effective. These films will hereinafter be referred to as porous β-films. In order to improve the porosity, a higher orientation in the longitudinal direction can be introduced before the transverse drawing. WO2010145770 describes a biaxially orientated single- or multi-layer microporous film with a shut down function the microporosity of which is produced by transformation of β-crystallites upon drawing and which contains at least one shut down layer formed from polypropylene homopolymer and polyethylene and which loses its porosity in the event of overheating at just T>135° C., i.e. interrupts the flow of ions from anode to cathode.

The aim of the present invention is to provide a porous film or a separator for batteries which comprises a shut down function in the temperature range 120-150° C., high porosities and outstanding mechanical strength and in addition, which increases the heat resistance of the film so that even in the event of severe overheating as a result, for example, of internal short-circuits or massive damage, it can keep the cathode and anode separated and thus also be used in high energy batteries in automobiles. Furthermore, the membrane should be capable of being produced by simple, environmentally-friendly and inexpensive processes.

Surprisingly, it has been discovered that inorganic, preferably ceramic, coated separator films based on porous polyolefin films can be produced when the inorganic, preferably ceramic coating is applied to a biaxially orientated, single- or multi-layered porous film the porosity of which is produced by transformation of β-crystalline polypropylene upon drawing the film, which comprises at least one porous layer and this layer contains at least one propylene and polyethylene polymer and β-nucleation agent, wherein the film has a Gurley number of <1000 s before coating.

Thus, the present invention concerns:

(I) a biaxially orientated, single- or multi-layered porous film which comprises at least one porous layer and this layer contains at least one propylene polymer and polyethylene;

(II) the porosity of the porous film is 30% to 80%; and (III) the permeability of the porous film is <1000 (Gurley number);

(IV) the porous film comprises an inorganic, preferably ceramic coating; and

(V) the coated porous film has a Gurley number of <1500 s; and

(VI) the coated porous film has a Gurley number of >6000 s when it is heated for 5 minutes to over 140° C.

### Separator Film

The inorganic, preferably ceramic, coated separator films based on porous polyolefin films of the invention comprise a porous, biaxially orientated film formed from polypropylene and polyethylene (BOPP) with a very high porosity and a high permeability of <1000 s (Gurley number). The use of such BOPP films as separator films is already known and preferably contain β-nucleation agents. The porosity of the film of the invention is preferably produced by transformation of β-crystalline polypropylene upon drawing the film, wherein at least one β-nucleation agent is present in the film. BOPP films of this type are also particularly suitable for use as separators in double layer condensers (DLC).

After longitudinal drawing, the films used in accordance with the invention for coating have a moderate orientation in the longitudinal direction and are then orientated in the transverse direction, so that as a BOPP film they have a high porosity and a very high permeability, and the tendency to split in the longitudinal direction is alleviated. It is advantageous herein for this transverse drawing to be carried out at a very slow draw speed, preferably of less than 40%/s.

The films used in accordance with the invention as a coating may be constructed as single- or multi-layered films. The production of such single-layered or multi-layered porous polypropylene films wherein polypropylene polymer and β-nucleation agent are melted in an extruder and extruded through a slot die onto a take-off roller has already been described in detail in DE-A-102010018374. The molten film cools on the take-off roller with the formation of β-crystallites and solidifies. Next, this film is drawn in the longitudinal direction and then immediately in the transverse direction.

Instead of the immediate transverse drawing, the films used in accordance with the invention for coating can also be rolled up after drawing in the longitudinal direction and at a later time can be unrolled in a second transverse drawing procedure, heated to the transverse drawing temperature and drawn in the transverse direction, wherein the draw speed for the longitudinal drawing procedure is greater or smaller than the draw speed of the transverse drawing procedure.

The porous BOPP films used for coating in accordance with the invention comprise at least one porous layer which is constructed from propylene polymers, polyethylene polymers and/or propylene block copolymers and contains β-nucleation agents. If necessary, other polyolefins may be contained therein in small quantities, as long as they do not impair the porosity and other essential properties. Furthermore, the microporous layer may also, if necessary, contain the usual additives, for example stabilizers and/or neutralizing agents, each in effective quantities.

For the purposes of this invention, the preferred polyethylenes in the shut down layer are HDPE or MDPE. These polyethylenes such as HDPE and MDPE are generally incompatible with polypropylene, and when blended with polypropylene, they form a separate phase. The existence of a separate phase is revealed in a DSC measurement, for example by the presence of a separate melt peak in the region of the melting temperature for polyethylene, generally in a range from 115-140° C. HDPE generally has an MFI (50 N/190° C.) of more than 0.1 to 50 g/10 min, preferably 0.6 to 20 g/10 min, measured in accordance with DIN 53 735, and a viscosity number, measured in accordance with DIN 53 728 Part 4 or ISO 1191, in the range 100 to 450 cm³/g, preferably 120 to 280 cm³/g. The crystallinity is generally 35% to 80%, preferably 50% to 80%. The density, measured at 23° C. in accordance with DIN 53 479 method A or ISO 1183, is preferably in the range from >0.94 to 0.97 g/cm³. The melting point, measured by DSC (maximum of the melting curve, heating rate 20° C./min), is between 120° C. and 145° C., preferably 125° C. and 140° C. MDPE which is suitable generally has an MFI (50 N/190° C.) greater than 0.1 to 50 g/10 min, preferably 0.6 to 20 g/10 min, measured in accordance with DIN 53 735. The density, measured at 23° C. in accordance with DIN 53 479 method A or ISO 1183, is in the range >0.925 to 0.94 g/cm³. The melting point, measured by DSC (maximum of the melting curve, heating rate 20° C./min), is between 115° C. and 130° C., preferably 120-125° C.

It is also advantageous to the invention for the polyethylene to have a narrow melting range. This means that in a DSC of the polyethylene, the beginning of the melting range and the end of the melting range are separated by a maximum of 10K, preferably 3 to 8K. In this context, the extrapolated onset is taken as the beginning of the melting range, and correspondingly the end of the melting range is taken to be the extrapolated end of the melting curve (heating rate 10K/min).

The polyethylene forming the shut down function is preferably present in the porous BOPP films for coating used in accordance with the invention in quantities of at least 5% by weight with respect to the propylene polymers present and/or propylene block copolymers present, particularly preferably in quantities of at least 10% by weight.

Suitable propylene homopolymers contain 98% to 100% by weight, preferably 99% to 100% by weight of propylene units and have a melting point (DSC) of 150° C. or higher, preferably 155° C. to 170° C., and generally a melt flow index of 0.5 to 10 g/10 min, preferably 2 to 8 g/10 mm at 230° C., and with a force of 2.16 kg (DIN 53735). Preferred propylene homopolymers for the layer are isotactic propylene homopolymers with an n-heptane soluble fraction of less than 15% by weight, preferably 1% to 10% by weight. Isotactic propylene homopolymers with a high chain isotacticity of at least 96%, preferably 97-99% (¹³C-NMR; triad method) may also advantageously be used. These raw materials are known in the art as HIPP (highly isotactic polypropylene) or HCPP (highly crystalline polypropylene) polymers and are distinguished by the high degree of stereoregularity of their polymer chains, higher crystallinity and a higher melting point (compared with propylene polymers, which have a ¹³C-NMR isotacticity of 90% to <96%, which may also be used).

The parameters “melting point” and “melting range” are determined by DSC measurement and read from the DSC curve as described in the section on measurement methods.

If appropriate, the porous layer can additionally contain other polyolefins, as long as they do not impair the properties, in particular the porosity and the mechanical strength. Examples of other polyolefins are random copolymers of ethylene and propylene with an ethylene content of 20% by weight or less, random copolymers of propylene with C₄-C₈ olefins, with an olefin content of 20% by weight or less, and terpolymers of propylene, ethylene and butylene with an ethylene content of 10% by weight or less and with a butylene content of 15% by weight or less.

In a preferred embodiment, the porous layer is constructed solely from polyethylene polymers, propylene homopolymers and/or propylene block copolymers and β-nucleation agents, as well as stabilizers and neutralizing agents if appropriate. Here again, at least 5% by weight, particularly preferably at least 10% by weight of polyethylene is present.

Propylene block copolymers have a melting point of more than 140° C. to 170° C., preferably 145° C. to 165° C., in particular 150° C. to 160° C., and a melting point range which begins at over 120° C., preferably in the range 125-140° C. The co-monomer content, preferably the ethylene content, is in the range 1% to 20% by weight, for example, preferably in the range 1% to 10% by weight. The melt flow index of the propylene block copolymer is generally in the range 1 to 20 g/10 min, preferably 1 to 10 g/10 min.

In a preferred embodiment, the porous BOPP films for coating used in accordance with the invention do not contain any polyolefins which are produced with the aid of so-called metallocene catalysts.

Basically, the β-nucleation agent for the porous layer may be any known additive which promotes the formation of β-crystals of polypropylene on cooling a polypropylene melt. β-nucleation agents of this type and their mode of action in a polypropylene matrix are known in the art per se and will be described below in detail.

Polypropylene is known to have various crystal phases. On cooling a melt, usually the α-crystalline PP form is predominantly formed; it has a melting point in the range 155-170° C., preferably 158-162° C. By using a specific temperature profile, on cooling the melt, a small quantity of β-crystalline phase can be produced which, in contrast to the monoclinic α-modification, has a substantially reduced melting point of 145-152° C., preferably 148-150° C. Additives are known in the art which produce an increased fraction of the β-modification on cooling the polypropylene, for example γ-quinacridone, dihydroquinacridine or calcium salts of phthalic acid.

For the purposes of the present invention, preferably, highly active β-nucleation agents are used which, on cooling a propylene homopolymer melt, produce a β-fraction of 40-95%, preferably 50-85% (DSC). The β-fraction is determined from the DSC of the cooled propylene homopolymer melt. Preferably, for example, a two-component β-nucleation system formed from calcium carbonate and organic dicarbonic acids as described in DE 3610644 is used; this constitutes a reference thereto. Calcium salts of dicarbonic acids such as calcium pimelate or calcium suberate as described in DE 4420989 are particularly preferred; again, this constitutes a reference thereto. In addition, the dicarboxamides described in EP-0557721, in particular N,N-dicyclohexyl-2,6-naphthalenedicarboxamide, are suitable β-nucleation agents. In addition to the β-nucleation agents, it is also important to maintain a certain temperature range and dwell times at these temperatures while the non-drawn melt film is cooling in order to obtain a high fraction of β-crystalline polypropylene. The melt film is preferably cooled at a temperature of 60° C. to 140° C., in particular 80° C. to 130° C., for example 85° C. to 128° C. The growth of β-crystallites is also promoted by slow cooling, so the take-off speed, i.e. the speed at which the melt film passes over the first chill roller, should be slow so that the necessary dwell times at the selected temperatures are long enough. The take-off speed is preferably less than 25 m/min, particularly 1 to 20 m/min. The dwell time is generally 20 to 300 s, preferably 30 to 200 s.

The shut down layer I and the porous layer II can also each contain an additional propylene block copolymer as a further component. Propylene block copolymers of this type have a melting point of more than 140° C. to 170° C., preferably 150° C. to 165° C., in particular 150° C. to 160° C. and a melting range which begins at more than 120° C., preferably in the range 125-140° C. The quantity of co-monomer, preferably ethylene, is, for example, in the range 1% to 20% by weight, preferably 1% to 10% by weight. The melt flow index of the propylene block copolymers is generally in the range 1 to 20 g/10 min, preferably 1 to 10 g/min.

If necessary, both the shut down layer I and the porous layer II can contain other polyolefins in addition to the propylene homopolymers and propylene block copolymers as long as they do not have a negative influence on the porosity and mechanical strength of the shut down function. Examples of other polyolefins are random copolymers of ethylene and propylene with an ethylene content of 20% by weight or less, random copolymers of propylene with C₄-C₈ olefins with an olefin content of 20% by weight or less, terpolymers of propylene, ethylene and butylene with an ethylene content of 10% by weight or less and a butylene content of 15% by weight or less, or other polyethylenes such as LDPE, VLDPE or LLDPE.

Particularly preferred embodiments of the film of the invention contain 50 to 10000 ppm, preferably 50 to 5000 ppm, in particular 50 to 2000 ppm of calcium pimelate or calcium suberate as the β-nucleation agent in the porous layer.

The porous film can be single- or multi-layered. The thickness of the film is generally in the range 10 to 100 μm, preferably 15 to 60 μm, for example 15 to 40 μm. The surface of the porous film can be provided with a corona, flame or plasma treatment in order to improve filling with electrolytes.

In a multi-layered embodiment, the film comprises further porous layers which are constructed as described above, wherein the composition of the various porous layers do not necessarily have to be identical. For multi-layered embodiments, the thickness of the individual layers is generally 2 to 50 μm.

The density of the porous film to be coated is generally in the range 0.1 to 0.6 g/cm³, preferably 0.2 to 0.5 g/cm³.

The bubble point of the film to be coated should not be over 350 nm, preferably in the range 20 to 350, in particular 40 to 300, particularly preferably 50 to 300 nm, and the mean pore diameter should be in the range 50 to 100 nm, preferably in the range 60-80 nm.

The porosity of the porous film to be coated is generally in the range 30% to 80%, preferably 50% to 70%.

The porous film to be coated, in particular the porous BOPP film, has a defined roughness Rz (ISO 4287, roughness measurement, one line, amplitude parameter roughness profile, Leica DCM3D instrument, Gauss filter, 0.25 mm) which is preferably from 0.3 μm to 6 μm, particularly preferably 0.5 to 5 μm, in particular 0.5 to 3.5 μm.

### Ceramic Coating

The biaxially orientated single- or multi-layered porous film of the invention comprises a ceramic coating on at least one side of the surface.

The coating is electrically insulating.

The inorganic, preferably ceramic coating of the invention comprises ceramic particles which should also be understood to mean inorganic particles. The particle size, expressed as the D50 value, is in the range 0.05 to 15 μm, preferably in the range 0.1 to 10 μm. The choice of the exact particle size depends on the thickness of the inorganic, preferably ceramic coating. It has been shown here that the D50 value should not be more than 50% of the thickness of the inorganic, preferably ceramic coating, preferably not larger than 33% of the thickness of the inorganic, preferably ceramic coating, in particular not larger than 25% of the thickness of the inorganic, preferably ceramic coating. In a particularly preferred embodiment of the invention, the D90 value is no more than 50% of the thickness of the inorganic, preferably ceramic coating, preferably no more than 33% of the thickness of the inorganic, preferably ceramic coating, in particular no more than 25% of the thickness of the inorganic, preferably ceramic coating.

The term “inorganic, preferably ceramic particles” as used in the context of the present invention should be understood to mean all natural or synthetic minerals as long as they have the particle sizes given above. The inorganic, preferably ceramic particles can have any geometry, but spherical particles are preferred. Furthermore, the inorganic, preferably ceramic particles can be crystalline, partially crystalline (minimum 30% crystallinity) or non-crystalline.

The term “ceramic particle” as used in the context of the present invention should be understood to mean materials based on silicate raw materials, oxide raw materials, in particular metal oxides and/or non-oxide and non-metallic raw materials.

Suitable silicate raw materials include materials which have a SiO₄ tetrahedron, for example sheet or framework silicates.

Examples of suitable oxide raw materials, in particular metal oxides, are aluminium oxides, zirconium oxides, barium titanate, lead zirconate titanates, ferrites and zinc oxide.

Examples of suitable non-oxide and non-metallic raw materials are silicon carbide, silicon nitride, aluminium nitride, boron nitride, titanium boride and molybdenum silicide.

The particles used in accordance with the invention consist of electrically insulating materials, preferably a non-conducting oxide of the metals Al, Zr, Si, Sn, Ti and/or Y. The production of such particles is described in detail in DE-A-10208277, for example.

Among the inorganic, preferably ceramic particles are particles which in particular are based on oxides of silicon with the molecular formula SiO₂, as well as mixed oxides with the molecular formula AlNaSiO₂ and oxides of titanium with the molecular formula TiO₂; they may be present in the crystalline, amorphous or mixed form. Preferably, the inorganic, preferably ceramic particles are polycrystalline materials, in particular with a crystallinity of more than 30%.

The thickness of the inorganic, preferably ceramic coating of the invention is preferably 0.5 μm to 80 μm, in particular 1 μm to 40 μm.

The quantity of inorganic, preferably ceramic coating applied is preferably 0.5 g/m² to 80 g/m², in particular g/m² to 40 g/m², with respect to the binder plus particles after drying.

The quantity of inorganic, preferably ceramic particles applied is preferably 0.4 g/m² to 60 g/m², in particular 0.9 g/m² to 35 g/m², with respect to the particles following drying.

The inorganic, preferably ceramic coating of the invention comprises inorganic, preferably ceramic particles which preferably have a density in the range 1.5 to 5 g/cm³, preferably 2 to 4.5 g/cm³.

The inorganic, preferably ceramic coating of the invention comprises inorganic, preferably ceramic particles which preferably have a minimum hardness of 2 on the Moh scale.

The inorganic, preferably ceramic coating of the invention comprises inorganic, preferably ceramic particles which preferably have a melting point of at least 160° C., in particular at least 180° C., particularly preferably at least 200° C. Furthermore, the said particles also do not decompose at the said temperatures. The data given above can be determined using known methods, for example DSC (differential scanning calorimetry) or TG (thermogravimetry).

The inorganic, preferably ceramic coating of the invention comprises inorganic, preferably ceramic particles which preferably have a minimum compressive strength of 100 kPa, particularly preferably a minimum of 150 kPa, in particular a minimum of 250 kPa. The term “compressive strength” means that a minimum of 90% of the particles present are not destroyed by the applied pressure.

Preferred coatings have a thickness of 0.5 μm to 80 μm and inorganic, preferably ceramic particles in the range 0.05 to 15 μm (D50 value), preferably in the range 0.1 to 10 μm (D50 value).

Particularly preferred coatings have (i) a thickness of 0.5 μm to 80 μm, (ii) inorganic, preferably ceramic particles in the range 0.05 to 15 μm (D50 value), preferably in the range 0.1 to 10 μm (D50 value), with a minimum compressive strength of 100 kPa, particularly preferably a minimum of 150 kPa, in particular a minimum of 250 kPa.

Particularly preferred coatings have (i) a thickness of 0.5 μm to 80 μm, (ii) inorganic, preferably ceramic particles in the range 0.05 to 15 μm (D50 value), preferably in the range 0.1 to 10 μm (D50 value), with a minimum compressive strength of 100 kPa, particularly preferably a minimum of 150 kPa, in particular a minimum of 250 kPa, and the D50 value is no more than 50% of the thickness of the inorganic, preferably ceramic coating, preferably no more than 33% of the thickness of the inorganic, preferably ceramic coating, in particular no larger than 25% of the thickness of the inorganic, preferably ceramic coating.

In addition to the cited inorganic, preferably ceramic particles, the inorganic, preferably ceramic coating of the invention comprises at least one final consolidating binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, for example PTFE, and blends thereof.

The binders used in accordance with the invention should be electrically insulating, i.e. not exhibit any electrical conductivity. “Electrically insulating” or “no electrical conductivity” means that these properties can be present to a small extent, but do not increase the values for the uncoated film.

The quantity of final consolidating binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, for example PTFE, and blends thereof is preferably 0.05 g/m² to 20 g/m², in particular 0.1 g/m² to 10 g/m² [binder only, dry]. Preferred ranges for binders based on polyvinylidene dichloride (PVDC) are 0.05 g/m² to 20 g/m², preferably 0.1 g/m² to 10 g/m² [binder only, dry].

The inorganic, preferably ceramic coating of the invention comprises, with respect to the binder and inorganic, preferably ceramic particles in the dry state, 98% by weight to 50% by weight of inorganic, preferably ceramic particles and 2% by weight to 50% by weight of binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, for example PTFE, and blends thereof, wherein of the binders, final consolidating binders based on polyvinylidene dichloride (PVDC) are preferred. Furthermore, the inorganic, preferably ceramic coating of the invention can also contain small amounts of additives which are only necessary for manipulation of the dispersion.

The inorganic, preferably ceramic coating of the invention is applied using known techniques, in particular with an applicator blade or by spraying onto the porous BOPP film.

Preferably, the inorganic, preferably ceramic coating is applied as a dispersion. These dispersions are preferably aqueous dispersions and in addition to the inorganic, preferably ceramic particles of the invention, comprise at least one of the cited binders, preferably binders based on polyvinylidene dichloride (PVDC), water and if necessary, organic substances which improve the stability of the dispersion or the wettability towards the porous BOPP film. The organic substances are volatile organic substances such as mono- or poly-alcohols, in particular those with a boiling point which does not exceed 140° C. Isopropanol, propanol and ethanol are particularly preferred because of their availability.

Application of the inorganic, preferably ceramic particles is described in detail in DE-A-10208277, for example.

Preferred dispersions comprise:

(i) 20% by weight to 90% by weight, particularly preferably 30% by weight to 80% by weight of inorganic, preferably ceramic particles;

(ii) 1% by weight to 30% by weight, particularly preferably 1.5% by weight to 20% by weight of binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, for example PTFE, and blends thereof, wherein of the binders, final consolidating binders based on polyvinylidene dichloride (PVDC) are preferred;

(iii) if appropriate, 1% by weight to 30% by weight, particularly preferably 0.01% by weight to 0.5% by weight of organic substances which improve the stability of the dispersion or the wettability onto the porous BOPP film, in particular mono- or poly-alcohols;

(iv) if appropriate, 0.00001% by weight to 10% by weight, particularly preferably 0.001% by weight to 5% by weight of further additives such as dispersion stabilizers and/or defoaming agents;

(v) water, so that the sum of all components is 100% by weight.

The present invention further concerns a process for the production of the inorganic, preferably ceramic, coated porous BOPP film in accordance with the invention. According to this process, the porous film is produced using the flat film extrusion or co-extrusion process which is known per se. This process is carried out in such a manner that the blend of propylene homopolymer and/or propylene block copolymer, polyethylene and β-nucleation agent and if appropriate, other polymers of the respective layer are mixed together, melted in an extruder and if necessary extruded or co-extruded simultaneously and together through a slot die onto a take-off roller, on which the single- or multi-layered molten film solidifies and cools with the formation of the β-crystallites. The cooling temperature and cooling times are selected so that the fraction of β-crystalline polypropylene which is formed in the pre-film is as high as possible. In general, this temperature of the take-off roller or the take-off rollers is 60° C. to 140° C., preferably 80° C. to 130° C. The dwell time at this temperature can vary and should be at least 20 to 300 s, preferably 30 to 100 s. The pre-film which is obtained thereby generally contains 40-95%, preferably 50-85% by weight of β-crystallites.

This pre-film with a high β-crystalline polypropylene fraction is then drawn biaxially in such a manner that drawing brings about a transformation of the β-crystallites into α-crystalline polypropylene and the formation of a matrix-like porous structure. The biaxial drawing (orientation) is generally carried out one after the other, wherein preferably, longitudinal drawing (in the machine direction) is carried out first, followed by the transverse drawing (perpendicular to the machine direction).

Regarding drawing in the longitudinal direction, firstly, the cooled pre-film is initially guided over one or more heating rollers, which heat the film to the appropriate temperature. In general, this temperature is less than 140° C., preferably 70° C. to 120° C. The longitudinal draw is then generally carried out with the aid of two rollers which run at different speeds as appropriate for the targeted draw ratio. The longitudinal draw ratio here is in the range 2:1 to 6:1, preferably 3:1 to 5:1. To prevent the orientation being too high in the longitudinal direction, the shrinkage in width upon longitudinal drawing is kept low, for example by installing a comparatively narrow draw gap. The length of the draw gap is generally 3 to 100 mm, preferably 5 to 50 mm. If appropriate, fixed elements such as expanders can contribute to a low shrinkage in width. The shrinkage should be less than 10%, preferably 0.5-8%, in particular 1-5%.

Following this longitudinal draw, the film is initially once more cooled over appropriate tempered rollers.

Next, in the so-called heating zones, it is re-heated to the transverse drawing temperature which is generally at a temperature of 120-145° C. Next, transverse drawing is carried out using an appropriate tenter frame, wherein the transverse draw ratio is in the range 2:1 to 9:1, preferably 3:1 to 8:1. In order to obtain the high porosities of the invention, transverse drawing is carried out with a moderate to slow transverse draw speed of >0 to 40%/s, preferably in the range 0.5% to 30%/s, in particular 1% to 15%/s.

If necessary, after the final draw, generally transverse drawing, a surface of the film is corona, plasma or flame treated so that filling with electrolyte is promoted. Preferably, the surface of the film which is not subsequently coated is treated in this manner.

Finally, thermofixing (heat treatment) is carried out if necessary, wherein the film is held at a temperature of 110° C. to 150° C., preferably 125° C. to 145° C. for approximately 5 to 500 s, preferably 10 to 300 s, for example over rollers or a hot air cabinet. If appropriate, the film is guided convergently immediately before or during thermofixing, wherein the convergence is preferably 5-25%, in particular 8% to 20%. The term “convergence” should be understood to mean slight running together of the transverse draw frame so that the maximum width of the frame at the end of the transverse drawing process is larger than the width at the end of thermofixing. Clearly, the same applies for the width of the film web. The degree of convergence of the transverse drawing frame is given as the convergence, which is calculated from the maximum width of the transverse drawing frame Bₘₐₓ and the final film width B_{film} using the following formula:

Convergence [%]=100×(Bₘₐₓ−B_{film})/Bₘₐₓ

Finally, the film is rolled up in the usual manner using take-up equipment.

In the known sequential processes wherein longitudinal and transverse drawing are carried out one after the other in one process, it is not just the transverse drawing rate which is dependent on the process speed. The take-off speed and the cooling speed also vary as a function of the process speed. These parameters thus cannot be selected independently of each other. It follows that under otherwise identical conditions, for a slower process speed, not only is the transverse drawing speed reduced, but also the cooling or take-off speed of the pre-film. This can, but not necessarily does, cause an additional problem.

In a further embodiment of the process of the invention, it is thus advantageous for the process for the production of the sequentially drawn film to be divided into two separate processes, i.e. into a first process which comprises all of the steps of the process up to and including the final cooling following longitudinal drawing, hereinafter termed the longitudinal drawing process, and into a second process which comprises all of the process steps after the longitudinal drawing process, hereinafter termed the transverse drawing process. This embodiment of the process of the invention as a two-step process means that it is possible to select the process speed of the first process and thus the respective conditions, in particular cooling and take-off speeds, as well as the longitudinal drawing conditions, independently of the transverse drawing speed. Similarly, in the second transverse drawing process, the transverse drawing speed can be slowed down in any manner, for example by reducing the process speed or by lengthening the draw frame, without having a negative impact on the formation of the β-crystallites or the longitudinal draw conditions. This variation of the process is implemented by carrying out the longitudinal drawing process as described above and then rolling up the film after cooling this longitudinally drawn film. This longitudinally drawn film is then used in the second transverse drawing process, i.e. in this second process, all of the steps of the process after cooling the longitudinally drawn film as described above are carried out. In this way, the optimum transverse drawing speed can be selected independently.

The term “process speeds” as cited above for the longitudinal drawing process or the transverse drawing process or the sequential process in each case should be understood to mean that speed, for example in m/min, at which the film runs for the respective final winding up. Depending on the circumstances, the transverse drawing process can advantageously have either a faster or a slower process speed than the longitudinal drawing process.

The process conditions in the process of the invention for the production of the porous films differ from the process conditions which are usually applied for the production of a biaxially orientated film. In order to obtain a high porosity and permeability, both the cooling conditions for solidification to form a pre-film and also the temperatures and the factors for drawing are critical. Firstly, appropriately slow and moderate cooling, i.e. comparatively high temperatures, have to be employed to obtain a high β-crystallite fraction in the pre-film. In the subsequent longitudinal drawing, the β-crystals are transformed into the alpha modification, wherein flaws are produced in the form of micro-cracks. So that these flaws are obtained in sufficient numbers and in the correct shape, longitudinal drawing has to be carried out at comparatively low temperatures. Upon transverse drawing, these flaws are broken into pores so that the characteristic network structure of these porous films is formed.

These low temperatures compared with the usual BOPP processes, in particular during longitudinal drawing, require high draw forces which on the one hand introduce a high orientation into the polymer matrix and on the other hand increase the risk of tearing off. The higher the desired porosity, then the lower must be the temperatures on drawing and the draw factors have to be increased accordingly. Thus, the process is fundamentally more critical as the porosity and permeability of the film are increased. The porosity can thus not be increased in an unlimited manner using higher draw factors or lower drawing temperatures. In particular, the reduced longitudinal drawing temperature results in a highly impaired operational reliability of the film and an unwanted increase in the splitting tendency. The porosity can thus no longer be improved by lower longitudinal drawing temperatures of less than 70° C., for example.

Furthermore, it is possible for the porosity and permeability of the film to be additionally influenced by the draw speed upon transverse drawing. A slow transverse draw speed increases the porosity and permeability further without multiplying tearing or other flaws during the production process. The film exhibits a special combination of high porosity and permeability, mechanical strength, good operational reliability during the production process and low tendency to split in the longitudinal direction.

Subsequently, the inorganic, preferably ceramic coating of the invention is applied to the previously prepared porous BOPP film using known technologies, for example applicator blades or sprays or printing, in the form of a dispersion, preferably an aqueous dispersion, onto the porous BOPP film.

To this end, an inorganic, preferably ceramic coating is applied directly to the previously prepared porous BOPP film, so that it is not necessary to carry out a pre-treatment of the film with primers or to use primers in the ceramic coating mass used for coating. Furthermore, it has been shown that, in particular with porous BOPP films, no post-treatment of the surface of the film, in particular the side of the film which is then to be coated, needs to be carried out using the known corona, plasma or flame treatment methods and the inorganic, preferably ceramic coating, can be applied directly to the porous BOPP film.

Preferably, the amount of dispersion applied is between 1 g/m² and 80 g/m². Next, the freshly coated porous BOPP film is dried using the usual industrial dryers, whereupon the binder which is present cures. Drying is normally carried out at temperatures in the range 50° C. to 140° C. The drying period in this case is between 30 seconds and 60 minutes.

By means of the present invention, a film can be made available which, because of its high permeability, is suitable for use in high energy batteries and at the same time satisfies the requirements for mechanical strength, in particular a low tendency to split, and it also has the thermal stability required for this application.

Furthermore, the film can advantageously be employed in other applications where a very high permeability is required or would be advantageous. An example is as a high porosity separator in batteries, in particular in lithium batteries with a high power requirement.

The inorganic, preferably ceramic, coated separator films based on porous polyolefin films of the invention comprise a porous biaxially orientated film formed from polypropylene with a porosity of 30% to 80% and a permeability of <1000 s (Gurley number) and the permeability of the separator films with a ceramic coating of the invention is <1500 s (Gurley number).

The inorganic, preferably ceramic coating on the separator film of the invention has good adhesion, which is obtained without the intervention of primers. The adhesion is determined as follows:

If the adhesion of the coating is poor, the coating flakes off from the edges and can be rubbed off with the fingers.

If the adhesion is good, a crack at most appears on the bent edge, but the adhesion to the film remains intact.

The following measuring methods were used to characterize the raw materials and the films:

### Particle Size Definition and Determination:

The mean particle diameter or the mean grain size (=D50 or D90) was determined by a laser scattering method in accordance with ISO 13320-1. An example of a suitable instrument for particle size analysis is a Microtrac S 3500.

### Melt Flow Index:

The melt flow index of the propylene polymers was measured in accordance with DIN 53 735 under a load of 2.16 kg and at 230° C.

### Melting Point:

The melting point in the context of the present invention is the maximum of the DSC curve. To determine the melting point, a DSC curve was used with a heating and cooling speed of 10K/1 min in the range 20° C. to 200° C. To determine the melting point, as is usual, the second heating curve at 10K/1 min was recorded after cooling from 200° C. to 20° C. at 10K/1 min.

### β-Content of the Pre-Film:

The β-content of the pre-film was also determined using a DSC measurement, carried out on the pre-film in the following manner: the pre-film was first heated to 220° C. and melted in the DSC at a heating rate of 10K/min, and then cooled again. From this 1 heating curve, the degree of crystallinity K_{β,DSC} was determined as the ratio of enthalpy of fusion of the β-crystalline phase (H_{β}) to the sum of the enthalpy of fusion of the β- and α-crystalline phases (H_{β}+H_{α}).

K_{β,DSC}[%]=100×H_{β}/(H_{β}+H_{α})

### Density:

The density was determined in accordance with DIN 53 479, Method A.

### Bubble Point:

The bubble point was determined in accordance with ASTM F316.

### Porosity:

The porosity was calculated as the reduction in density (ρ_{film}−ρₚₚ) of the film with respect to the density of the pure polypropylene, ρₚₚ, as follows:

Porosity [%]=100×(ρₚₚ−ρ_{film})/ρₚₚ

### Permeability (Gurley Number)

The permeability of the films was measured in accordance with ASTM D 726-58 using the Gurley Tester 4110. Here, the time (in seconds) required by 100 cm³ of air to permeate through an area of 1 square inch (6.452 cm²) of the specimen was determined. The pressure differential across the film corresponds to the pressure of a 12.4 cm high column of water. The time required corresponds to the Gurley number.

### Shut Down Function:

The shut down function was determined on the basis of Gurley measurements taken before and after heat treatment at a temperature of 135° C. The Gurley number of the film was measured as described previously. Next, the film was exposed to a temperature of 135° C. in a warming oven for five minutes. The Gurley number was then determined again, as described. The shut down function is operative if the film has a Gurley value of at least 5000 s and has increased at least 1000 s after the heat treatment.

### Shrinkage:

The shrinkage gives the change width of the film during longitudinal drawing. In this case, B₀ defines the width of the film before and B₁ defines the width of the film after longitudinal drawing. The longitudinal direction is the machine direction; the transverse direction is the direction transverse to the machine direction. Thus, the shrinkage as a % is the difference in the determined widths with respect to the original width B₀ multiplied by 100:

Shrinkage B [%]=[(B₀−B₁)/B₀]×100 [%]

### Adhesion:

A 6×6 cm piece of film was cut out using a template. This piece was applied with a 3 cm overlap to a stainless steel cube with an edge radius of 0.5 mm and dimensions of 8×8×8 cm. The protruding 3 cm was then bent at a right angle over the edge of the cube. If the adhesion of the coating was poor, the coating flaked off at the edge and could be rubbed off with the fingers.

If the adhesion was good, at most a crack appeared at the bent edge, but adhesion of the film was retained.

The invention will now be illustrated with reference to the following examples.

### EXAMPLES

Three different inorganic coatings were made up for the inorganic, preferably ceramic coating. To this end, a commercially available PVDC coating (DIOFAN® A 297) was used as a binder with the inorganic particles; water and isopropanol were added in a manner so as to adjust the viscosity of the coating to allow uniform distribution of the DIOFAN® A 297 onto the polypropylene film using a wire applicator blade. In addition, the fraction of the PVDC was selected so that on the one hand, after drying off the solvent component, an abrasion-resistant coating was formed and on the other hand, there was still enough open (coating-free) zones between the ceramic particles for an open, air-permeable porous structure to be formed. The composition of the coating mass is shown in detail in Table 1. The organic particles were spherical silicate particles (Zeeospheres™, 3M) and TiO₂ particles.

### Production of Films Mentioned in the Example

TABLE 1
Composition of inorganic coatings

| | | | Particle, % by | Water, % by | | |
|---|---|---|---|---|---|---|
| | Particle | Particle size | weight | weight | Isopropanol, % | PVDC coating |
| Coating 1 | Spherical | 1-10 μm | 65 | 13 | 8 | 13 |
| | silicate | | | | | |
| | (SiO₂) | | | | | |
| Coating 2 | Spherical | 1-10 μm | 58 | 17 | 8 | 17 |
| | silicate | | | | | |
| | (SiO₂) | | | | | |
| Coating 3 | TiO₂ | 100-300 nm | 47 | 23 | 12 | 18 |

### Film Example 1

In the extrusion process, a single ply pre-film was extruded from a slot die at an extrusion temperature of 240° C. to 250° C. This pre-film was first taken off onto a chill roller and cooled down. The pre-film was then orientated longitudinally and transversely and finally fixed. The film had the following composition:

Approximately 60% by weight of highly isotactic propylene homopolymerisate (PP) with a ¹³C-NMR isotacticity of 97% and an n-heptane soluble fraction of 2.5% by weight (relative to 100% PP) and a melting point of 165° C.; and a melt flow index of 2.5 g/10 min at 230° C. and 2.16 k load (DIN 53 735); and

approximately 20% by weight of HDPE (high density polyethylene) with a density of 0.954 (ISO 1183) and an MFI of 0.4 g/10 min at 190° C. and 2.16 kg load (ISO 1133/D) or 27 g/10 min at 190° C. and 21.6 kg load (ISO 1333/G) and a melting point of 130° C. (DSC: peak at 10° C./min heating rate); the melt range began at 125° C., approximately 20% by weight of propylene-ethylene block copolymerisate with an ethylene content of 5% by weight with respect to the block copolymer and an MFI (230° C. and 2.16 kg) of 6 g/10 min and a melting point (DSC) of 165° C.; and

0.04% by weight of Ca pimelate as β-nucleation agent.

The film additionally contained the usual small quantities of stabilizer and neutralising agent.

After extrusion, the molten polymer blend was taken off and solidified over a first take-off roller and a further roller trio, then drawn longitudinally, transversely and fixed; details of the conditions are as follows:

Extrusion: extrusion temperature 235° C.

Take-off roller: temperature 125° C.,

Take-off speed: 4 m/min

Longitudinal drawing: drawing roller T=90° C.

Longitudinal drawing: factor 3.0

transverse drawing: heating zones T=−125° C.

Drawing zones: T=125° C.

Transverse drawing: factor 5.0

Fixing: T=125° C.

The porous film produced in this manner was about 25 μm thick, had a density of 0.38 g/cm³ and had an even, white-opaque appearance.

### Film Example 2

In the extrusion process, a single ply pre-film was extruded from a slot die at an extrusion temperature of 240 to 250° C. The extrusion throughput was increased by 30% compared with film example 1. This pre-film was first taken off onto a chill roller and cooled down. The pre-film was then orientated longitudinally and transversely and finally fixed. The film had the following composition:

Approximately 80% by weight of highly isotactic propylene homopolymerisate (PP) with a ¹³C-NMR isotacticity of 97% and an n-heptane soluble fraction of 2.5% by weight (relative to 100% PP) and a melting point of 165° C.; and a melt flow index of 2.5 g/10 min at 230° C. and 2.16 kg load (DIN 53 735); and

approximately 20% by weight of HDPE (high density polyethylene) with a density of 0.954 (ISO 1183) and an MFI of 0.4 g/10 min at 190° C. and 2.16 kg load (ISO 1133/D) or 27 g/10 min at 190° C. and 21.6 kg load (ISO 1333/G) and a melting point of 130° C. (DSC: peak at 10° C./min heating rate); the melt range began at 125° C. Further, the film contained 0.04% by weight of Ca pimelate as β-nucleation agent.

The film additionally contained the usual small quantities of stabilizer and neutralising agent.

After extrusion, the molten polymer blend was taken off and solidified over a first take-off roller and a further roller trio, then drawn longitudinally, transversely and fixed; details of the conditions are as follows:

Extrusion: extrusion temperature 235° C.

Take-off roller: temperature 125° C.,
dwell time on take-off roller 60 sec

Longitudinal drawing: drawing roller T=90° C.

Longitudinal drawing: factor 3.0

Transverse drawing: heating zones T=125° C.

Drawing zones: T=125° C.

Transverse drawing: factor 5.0

Fixing: T=125° C.

The porous film produced in this way was about 30 μm thick, had a density of 0.3 g/cm³ and had an even, white-opaque appearance. The Gurley number was 380 s. After the heat treatment in the oven at 135° C. for 5 min, the Gurley number was >9000 s/100 cm³.

### Example 1

Silicate coating with the composition of coating 1 (Table 1) was manually applied using a wire applicator blade (wire diameter: 0.4 mm) to a microporous BOPP film with a shut down function (film example 1). Wetting of the film with the ceramic suspension was uniform. The coated film was then dried for one hour at 90° C. in a drying cabinet. After drying, the coating exhibited good adhesion to the film. Next, the coating weight, thickness of the coating layer and the permeability to air were determined using the Gurley number. Only a slight increase in the Gurley number was observed, from 360 s to 380 s.

### Example 2

Silicate coating with the composition of coating 2 (Table 1) was manually applied using a wire applicator blade (wire diameter: 0.4 mm) to a microporous BOPP film with a shut down function (film example 1). After coating, wetting of the film with the ceramic suspension was uniform. After drying, the coating, as was the case for Example 2, exhibited better adhesion than in Example 5. The Gurley number was also substantially higher. The Gurley number was observed to have increased from 360 s to 570 s.

### Example 3

Titanium oxide coating with the composition of coating (Table 1) was manually applied using a wire applicator blade (wire diameter: 0.4 mm) to a microporous BOPP film with a shut down function (film example 1). After coating, wetting of the film with the ceramic suspension was uniform. After drying, the coating exhibited good adhesion to the film. An increase in the Gurley number was observed, from 360 s to 460 s.

### Example 4

Silicate coating with the composition of coating 1 (Table 1) was manually applied using a wire applicator blade (wire diameter: 0.7 mm) to a microporous BOPP film with a shut down function (film example 2). After coating, wetting of the film with the ceramic suspension was uniform. After drying, adhesion of the coating was good. The Gurley number increased from 380 to 420 s.

### Example 5

Titanium oxide coating with the composition of coating 3 (Table 1) was manually applied using a wire applicator blade (wire diameter: 0.7 mm) to a microporous BOPP film with a shut down function (film example 1). After coating, wetting of the film with the ceramic suspension was uniform. After drying, the coating exhibited good adhesion to the film. An increase in the Gurley number was observed, from 380 s to 510 s.

### Example 6

### Comparative

An attempt was made to manually apply the silicate coating with the composition of coating 1 (Table 1) to a commercially available microporous separator from Celgard (C200) as described in Example 1 using a wire applicator blade (wire diameter 0.4 mm). No wetting by the coating solution was observed and it flaked off again after drying.

### Example 7

### Comparative

An attempt was made to manually apply the silicate coating with the composition of coating 2 (Table 1) to the separator from Celgard (C200) as described in Example 2 using a wire applicator blade (wire diameter 0.4 mm). Again, no wetting by the coating solution, with an increased PVDC content, was observed and it flaked off again after drying.

### Example 8

### Comparative

An attempt was made to manually apply the silicate coating with the composition of coating 1 (Table 1) to another commercially available polyolefin separator from UBE as described in Example 1 using a wire applicator blade (wire diameter 0.4 mm). The coating solution exhibited no wetting and flaked off again after drying.

### Example 9

### Comparative

An attempt was made to manually apply the silicate coating with the composition of coating 2 (Table 1) to the polyolefin separator from UBE as described in Example 2 using a wire applicator blade (wire diameter 0.4 mm). Again, the coating with an increased PVDC content exhibited no wetting and flaked off again after drying.

### Example 10

### Comparative

An attempt was made to manually apply the silicate coating with the composition of coating 1 (Table 1) to a commercially available biaxially drawn polypropylene packaging film (GND 30 from Treofan) which, for the purposes of printability, had been treated by corona treatment to increase the surface tension compared with untreated PP films, in the manner of Example 1 using a wire applicator blade (wire diameter 0.4 mm). Again, the coating with an increased PVDC content exhibited no wetting and flaked off again after drying.

### Example 11

### Comparative

Coating 2, with the increased PVDC content, also exhibited no wetting and adhesion to the biaxially drawn polypropylene packaging film GND 30 from Treofan.

TABLE 2

| | | | | | | Shut down | | | | |
|---|---|---|---|---|---|---|---|---|---|---|
| | | | Wire | Gurley | Gurley | function | | | | |
| | | | diameter | number | number | Gurley | Layer | | | |
| | Separator/ | Coating | applicator, | before | after | number | thickness | Coating | | |
| | film type | formula | mm | coating | coating | 5 min@ 135° C. | coating/μm | weight/g/m² | Wetting | Adhesion |
| Ex 1 | PBS 20 | Coat 1 | 0.4 | 360 | 380 | >5000 s | 37 | 53 | yes | yes |
| Ex 2 | PBS 20 | Coat 2 | 0.4 | 360 | 570 | >5000 s | 33 | 50 | yes | yes |
| Ex 3 | PBS 20 | Coat 3 | 0.4 | 360 | 460 | >5000 s | 35 | 59 | yes | yes |
| Ex 4 | PBS 30 | Coat 1 | 0.7 | 380 | 420 | >5000 s | 52 | 63 | yes | yes |
| Ex 5 | PBS 30 | Coat 3 | 0.7 | 380 | 510 | >5000 s | 52 | 63 | yes | yes |
| Ex 6 (C) | Celgard C | Coat 2 | 0.4 | 660 | — | >5000 s | — | — | None | None |
| | 200 | | | | | | | | | |
| Ex 7 (C) | Celgard C | Coat 3 | 0.4 | 660 | — | >5000 s | — | — | None | None |
| | 200 | | | | | | | | | |
| Ex 8 (C) | UBE 3014 | Coat 2 | 0.4 | 580 | — | >5000 s | — | — | None | None |
| Ex 9 (C) | UBE 3014 | Coat 3 | 0.4 | 580 | — | >5000 s | — | — | None | None |
| Ex 10 (C) | GND 30 | Coat 2 | 0.4 | — | — | — | — | — | None | None |
| Ex 11 (C) | GND 30 | Coat 3 | 0.4 | — | — | — | — | — | None | None |

1.-33. (canceled)

34. A biaxially orientated, single- or multi-layered porous film which comprises at least one porous layer and this layer contains at least one propylene polymer and polyethylene;
(I) the porosity of the porous film is 30% to 80%; and
(II) the permeability of the porous film is <1000 s (Gurley number);
wherein
(III) the porous film comprises an inorganic coating; and
(IV) the coated porous film has a Gurley number of <1500 s; and
(V) the coated porous film has a Gurley number of >6000 s when it is heated for 5 minutes to over 140° C.

35. The film as claimed in claim 34, wherein the porosity is produced by transformation of β-crystalline polypropylene upon drawing the film, wherein at least one β-nucleation agent is present in the film.

36. The film as claimed in claim 34, wherein the propylene polymer is a propylene homopolymer and/or a propylene block copolymer.

37. The film as claimed in claim 35, wherein the β-nucleation agent is a calcium salt of pimelic acid and/or suberic acid and/or a nanoscale iron oxide.

38. The film as claimed in claim 34, wherein the film contains propylene homopolymer and propylene block copolymer.

39. The film as claimed in claim 35, wherein the film contains 50% to 85% by weight of propylene homopolymer, 15% to 50% by weight of propylene block copolymer and 50 to 10000 ppm of β-nucleation agent.

40. The film as claimed in claim 34, wherein the density of the film is in the range 0.1 to 0.5 g/cm³.

41. The film as claimed in claim 34, wherein the thickness of the film is 10 to 100 μm.

42. The film as claimed in claim 34, wherein the propylene polymers are not produced using metallocene catalysts.

43. The film as claimed in claim 34, wherein the polyethylene is present in quantities of at least 5% by weight with respect to the propylene polymers and/or propylene block copolymers present.

44. The film as claimed in claim 34, wherein the polyethylene is a HDPE or MDPE with a melting peak in the range 115° C. to 140° C.

45. The film as claimed in claim 44, wherein the HDPE has a MN (50 N/190° C.) of more than 0.1 to 50 g/10 min measured using DIN 53 735 and a viscosity number, measured using DIN 53 728 part 4 or ISO 1191, in the range 100 to 450 cm³/g, a density, measured at 23° C. in accordance with DIN 53 479, method A or ISO 1183, in the range >0.94 to 0.97 g/cm³ and a melting point, measured using DSC (maximum of melting curve, heating rate 20° C./min), between 120° C. and 145° C.

46. The film as claimed in claim 44, wherein the MDPE has a MFI (50 N/190° C.) of more than 0.1 to 50 g/10 min, measured using DIN 53 735, a density, measured at 23° C. in accordance with DIN 53 479, method A or ISO 1183, in the range >0.925 to 0.94 g/cm³ and a melting point, measured using DSC (maximum of melting curve, heating rate 20° C./min) between 115° C. and 130° C.

47. The film as claimed in claim 34, wherein the inorganic coating comprises ceramic particles with a particle size, expressed as the D50 value, in the range 0.05 to 15 μm.

48. The film as claimed in claim 47, wherein the ceramic particle comprises an electrically non-conducting oxide of the metals Al, Zr, Si, Sn, Ti and/or Y.

49. The film as claimed in claim 47, wherein the ceramic particles comprise particles based on oxides of silicon with the molecular formula SiO₂, as well as mixed oxides with the molecular formula AlNaSiO₂ and oxides of titanium with the molecular formula TiO₂, wherein they may be present in the crystalline, amorphous or mixed form.

50. The film as claimed in claim 47, wherein the ceramic particles have a melting point of at least 160° C.

51. The film as claimed in claim 34, wherein the thickness of the inorganic ceramic coating is 0.5 μm to 80 μm.

52. The film as claimed in claim 34, wherein the quantity of inorganic coating which is applied is 0.5 g/m² to 80 g/m².

53. The film as claimed in claim 47, wherein the quantity ceramic particles which is applied is 0.4 g/m² to 60 g/m².

54. The film as claimed in claim 34, wherein the inorganic coating further comprises a final consolidating binder based on polyvinylidene dichloride (PVDC).

55. The film as claimed in claim 34, wherein the inorganic coating comprises ceramic particles with a minimum compressive strength of 100 kPa.

56. The film as claimed in claim 54, wherein the applied quantity of final consolidating binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, for example PTFE, and blends thereof is 0.5 g/m² to 20 g/m².

57. The film as claimed in claim 34, wherein the inorganic coating comprises 98% by weight to 50% by weight of ceramic particles and 2% by weight to 50% by weight of at least one terminally consolidating binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, and blends thereof.

58. The film as claimed in claim 34, wherein the inorganic coating is applied directly to the porous film.

59. A process for the production of a coated film as defined in claim 35, comprising the following steps:
(i) extruding a single- or multi-layered porous polypropylene film in which propylene polymer and β-nucleation agent are melted in the presence of polyethylene in an extruder and extruded through a slot die onto a take-off roller;
(ii) then cooling and solidifying the extruded molten film, with the formation of β-crystallites;
(iii) then drawing this film in the longitudinal direction and thereafter in the transverse direction, wherein the transverse drawing is carried out with a slow drawing speed of less than 40%/sec and the film has a Gurley number of <1000 s after production;
(iv) applying a dispersion comprising:
(a) 20% by weight to 90% by weight, particularly preferably 30% by weight to 80% by weight of inorganic particles;
(b) 1% by weight to 30% by weight, particularly preferably 1.5% by weight to 20% by weight of binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, and blends thereof;
(c) optionally, 1% by weight to 30% by weight, of organic substances which improve the stability of the dispersion or the wettability onto the porous BOPP films;
(d) optionally, 0.00001% by weight to 10% by weight, of further additives;
(e) water, so that the sum of all or the components of the dispersion is 100% by weight;
(v) drying the porous film coated with the dispersion.

60. The process as claimed in claim 59, wherein the drawing in accordance with (iii) is carried out in two separate process steps.

61. The process as claimed in claim 59, wherein the porous BOPP film does not undergo any post-treatment of the surface of the film.

62. The process as claimed in claim 59, wherein after step (iii) and before applying the coating in step (iv), the porous BOPP film undergoes no further post-treatments and is coated directly.

63. The process as claimed in claim 59, wherein after step (iii) and before applying the coating in step (iv), the porous BOPP film has a roughness Rz of 0.3 μm to 6 μm.

64. A process for the production of the coated film as defined in claim 34 which comprises utilizing a dispersion comprising:
(a) 20% by weight to 90% by weight, particularly preferably 30% by weight to 80% by weight of inorganic particles;
(b) 1% by weight to 30% by weight, of binder selected from the group formed by binders based on polyvinylidene dichloride (PVDC), polyacrylates, polymethacrylates, polyethyleneimines, polyesters, polyamides, polyimides, polyurethanes, polycarbonates, silicate binders, graft polyolefins, polymers from the halogenated polymer class, for example PTFE, and blends thereof, wherein of the binders, binders based on polyvinylidene dichloride (PVDC) are preferred;
(c) optionally 1% by weight to 30% by weight, of organic substances which improve the stability of the dispersion or the wettability onto the porous BOPP film, in particular mono- or poly-alcohols;
(d) optionally 0.00001% by weight to 10% by weight, of further additives;
(e) water, so that the sum of all the components is 100% by weight.

65. A separator in high energy or high performance systems which comprises the film as claimed in claim 34.

66. High energy or high performance systems which comprise the film as claimed in claim 34.
